(19) United States
(12) Patent Application Publication
(10) Pub. No.: US 2013/0262668 A1
(43) Pub. Date: Oct. 3, 2013

(54) PORTABLE TERMINAL DEVICE, DATA MANAGEMENT METHOD, AND DATA MANAGEMENT PROGRAM

(71) Applicant: KYOCERA CORPORATION, Kyoto (JP)

(72) Inventor: Noritaka SHIGA, Kyotanabe-shi (JP)

(73) Assignee: KYOCERA CORPORATION, Kyoto (JP)

(21) Appl. No.: 13/804,488

(22) Filed: Mar. 14, 2013

(30) Foreign Application Priority Data
Mar. 28, 2012 (JP) 2012-074053

(51) Int. Cl. H04L 12/26

(52) U.S. Cl. CPC H04L 43/10
USPC 709/224

(57) ABSTRACT

A portable terminal device that is enabled to use data with a certain degree of protection against information leakage. The portable terminal device uses data stored in a server by communicating with the server via a network, and includes: a connection monitor that monitors a connection state of the portable terminal device with the server; and a data manager that deletes same data as data stored in the server from the portable terminal device when the connection monitor detects that the portable terminal device goes into the online state.

The disclosure of Japanese Patent Application No. 2012-074053 filed Mar. 28, 2012 including specification, drawings and claims is incorporated herein by reference in its entirety.

### TECHNICAL FIELD

The present invention relates to a portable terminal device that communicates with a server via a network, a data management method, and a data management program, and in particular to technology of using data stored in a server from a portable terminal device.

### BACKGROUND ART

In recent years, it has become common to save business data to a portable terminal device such as a mobile telephone to use the data outside the office. Accordingly, the risk of information leakage has been increased, since portable terminal devices are vulnerable to loss and theft.

Conventionally, there has been a known method to protect the data stored in a portable terminal device from being stolen by an unauthorized person. According to this method, the user can set a password to the portable terminal device. However, if a portable terminal device is stolen by a person with malicious intent, the password can be analyzed and the data stored in the portable terminal device can be stolen.

Meanwhile, there has been a proposal of a technology of saving data in a server connected to a network and allowing a portable terminal device to download the data from the server (e.g. Japanese Patent Application Publication No. 2011-250109). In addition, thin client systems are well-known. In a thin client system, a portable terminal device is not allowed to store data in view of the security, and only allowed to download data from a server when necessary. It is considered that such a system can considerably reduce the damage due to the information leakage even when the portable terminal device is stolen or lost.

### SUMMARY

However, a portable terminal device in a thin client system needs to connect to and communicate with a server via a network whenever using data. Therefore, when the portable terminal device cannot connect to the network and communicate with the server, the portable terminal device cannot use the data. This is problematic.

A portable terminal device that is enabled to use data with a certain degree of protection against information leakage is desirable.

One aspect of the present invention provides a portable terminal device for using data stored in a server by communicating with the server via a network, comprising: a connection monitor that monitors a connection state of the portable terminal device with the server, the connection state switching between an online state and an offline state; and a data manager that deletes same data as data stored in the server from the portable terminal device when the connection monitor detects that the portable terminal device goes into the online state.

### BRIEF DESCRIPTION OF DRAWINGS

FIG. 1 is a schematic view showing a relationship among a mobile telephone 10 pertaining to an embodiment of the present invention and a group of servers 60.

FIG. 2 is a functional diagram showing primary functional components of the mobile telephone 10 and the group of servers 60.

FIG. 3 shows a data structure of update information 100 and tis example contents.

FIG. 4 is a flowchart showing data management performed by the mobile telephone 10.

FIG. 5 is a flowchart showing uploading performed by an uploader 19 of the mobile telephone 10.

FIG. 6 is a functional diagram showing primary functional components of a mobile telephone 10A pertaining to a modification example and the group of servers 60.

### DESCRIPTION OF EMBODIMENTS

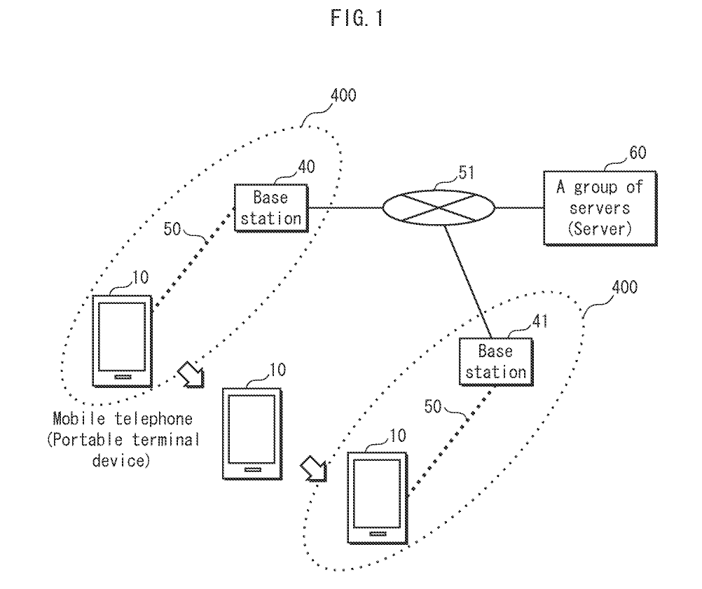

The following describes a mobile telephone as an embodiment of the present invention, with reference to FIG. 1 through FIG. 5. Note that the components commonly depicted in the drawings are marked by the same reference symbols.

### Embodiment

### <Outline>

FIG. 1 is a schematic view showing a relationship among a portable terminal device 10 pertaining to the present embodiment and a group of servers 60 (hereinafter simply referred to as “the server 60”).

The mobile telephone 10 has the function of using data stored in the server 60 by communicating with the server 60 via a communication network 50, base stations 40 and 41, and a communication network 51. The server 60 is a sort of a computer, and provides an online storage function to the mobile telephone 10 as a client device. The server 60 may consist of a plurality of physically separated servers, or of a plurality of virtual servers established in a single physical server. The communication network 50 is a wireless network for a mobile communication service, and specifically is a mobile telephone network such as W-CDMA, CDMA 2000, GSM and LTE, or a mobile WiMAX conforming to IEEE802.16e, for example. The communication network 51 is the Internet, a LAN, a Wi-Fi network, or the like.

As shown in FIG. 1, the mobile telephone 10 can use the communication network 50 within a coverage area 400 of the mobile communication service. When entering the coverage area 400, the mobile telephone 10 goes into the online state in which the mobile telephone 10 can communicate with the server 60. However, by its nature, the mobile telephone 10 sometimes goes out of the coverage area 400. In such a case, the mobile telephone 10 cannot use the communication network 50 and goes into the offline state in which the mobile telephone 10 cannot communicate with the server 60. After entering the coverage area 400 again, the mobile telephone 10 can use the communication network 50 and can communicate with the server 60.

Inside the coverage area 400, the mobile telephone 10 uses data stored in the server 60 by communicating with the server 60. Also, while being inside the coverage area 400, the mobile telephone 10 does not leave the data within the mobile telephone 10, in order to protect the data against information leakage in the case of loss of the mobile telephone 10.

When it is expected, by a prescribed method (based on whether a download condition is satisfied), that the mobile telephone 10 will go out of the coverage area 400, the mobile telephone 10 downloads the data stored in the server 60 just before going out of the coverage area 400. The prescribed method and the download condition will be described later. This procedure enable the user to use the downloaded data outside the coverage area 400. When going into the coverage area 400 again, the mobile telephone 10 deletes the downloaded data in order to ensure the security.

### <Structure>

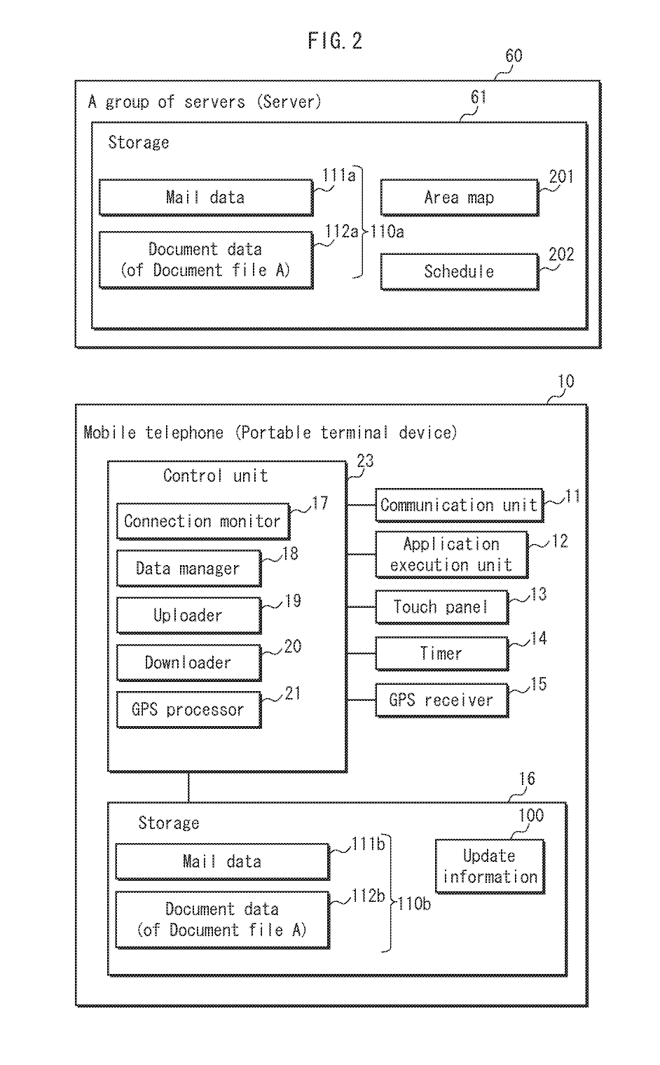

The following describes the structure of the mobile telephone 10 with reference to FIG. 2.

FIG. 2 is a functional diagram showing primary functional components of the mobile telephone 10 and the server 60. In FIG. 2, data set 110b stored in a storage 16 of the mobile telephone 10 has been downloaded from the server 60. That is, the data set 110b is a copy of a data set 110a stored in a storage 61 of the server 60. However, since the mobile telephone 10 can update the data set 110b, the data set 110b may be not exactly the same as the data set 110a, depending on timing. Each of the mail data 111a and the mail data 111b shown in FIG. 2 constitutes a received mail, a sent mail, or the like. Each of the document data 112a and the document data 112b is data of a document file (named “document file A”) created with word-processing software, a PDF file, or the like.

The mobile telephone 10 includes a communication unit 11, an application execution unit 12, a touch panel 13, a timer 14, a global positioning system (GPS) receiver 15, a storage 16, and a control unit 23.

The communication unit 11 includes a circuit and an antenna, which are used for transmission and reception of radio waves to and from the base stations 40 and 41. The communication unit 11 fulfills the function of demodulating a received signal and transmitting the signal to the control unit 23, and the function of modulating a signal received from the control unit 23 and outputting the modulated signal.

The application execution unit 12 executes an event-driven application according to an event generated based on a user instruction and notified from the control unit 23. In the present embodiment, the application execution unit 12 fulfills the function of enabling the user to browse the mail data 111b or edit the document data 112b according a user instruction indicating the user's intention to use the mail data 111b or the document data 112b.

The touch panel 13 fulfills the function of receiving a user instruction and the function of displaying the contents of the data set 110b in the storage 16 according to an instruction from the control unit 23. The touch panel 13 is formed by layering a capacitive touch sensor and a display panel such as a liquid crystal display (LCD).

The timer 14 obtains the current time, and specifically is a clock, for example.

The GPS receiver 15 includes a receiver circuit and an antenna for receiving radio waves from a GPS satellite. The signal received by the GPS receiver 15 is transmitted to a GPS processor 21 included in the control unit 23. The GPS processor 21 obtains the current position and the travelling speed of the mobile telephone 10 by using the signal. The travelling speed is represented by a vector with magnitude and direction.

The storage 16 is housed in the mobile telephone 10, and specifically is a flash memory, for example. In the present embodiment, the storage 16 stores the mail data 111b and the document data 112b. The storage 16 stores update information 100, which will be described later.

The control unit 23 includes a connection monitor 17, a data manager 18, an uploader 19, a downloader 20, and the above-mentioned GPS processor 21. Note that the mobile telephone 10 further includes a processor and a memory, and each functional component of the control unit 23 and the application execution unit 12 are realized by the processor executing a program stored in the memory.

The connection monitor 17 monitors whether the mobile telephone 10 can communicate with the server 60. As described above, the mobile telephone 10 is a mobile device, and therefore it may go into or go out of the coverage area 400 of the communication network 50. Accordingly, the connection state of the mobile telephone 10 with the server 60 switches between the online state and the offline state. The connection monitor 17 determines that the mobile telephone 10 can communicate with the server 60 (i.e. in the online state) when determining that the connection monitor 17 can communicate with the server 60. The connection monitor 17 determines that the mobile telephone 10 cannot communicate with the server 60 (i.e. in the offline state) when determining that the connection monitor 17 cannot communicate with the server 60. After determining that the connection monitor 17 cannot communicate with the server 60, the connection monitor 17 determines that the mobile telephone 10 goes into the online state when initially determining that the connection monitor 17 can communicate with the server 60. Also, when the online sate has continued for a predetermined time period (e.g. five minutes), the connection monitor 17 determines that the connection to the server 60 is stable (i.e. the stable online state). For example, the connection monitor 17 may determine the connection to the server 60 at predetermined intervals (e.g. one minute), and determine that the mobile telephone 10 is in the stable online state when having confirmed that the connection monitor 17 can communicate with the server 17 a predetermined number of times in a row (e.g. five times).

The data manager 18 manages the location of the data set 110b by determining whether the data set 110b has been updated in the mobile telephone 10, based on the update information 100 stored in the storage 16 of the mobile telephone 10.

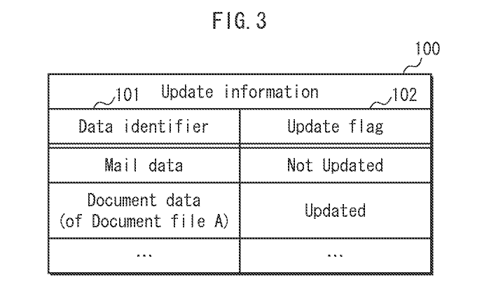

The following describes the update information 100 with reference to FIG. 3.

FIG. 3 shows a data structure of the update information 100 and its example contents.

The update information 100 is information for data management and is used by the data manager 18. Each record contained in the update information 100 consists of a data identifier 101 identifying the data stored in the mobile telephone 10 and an update flag 102 indicating whether the data has been updated within the mobile telephone 10. Each record contained in the update information 100 is added to the table of the update information 100 for each piece of data. That is, when data is downloaded from the server 60, one record is added to the update information 100. At this moment, information identifying the data is written into the data identifier 101, and an initial value indicating that the data has not been updated (hereinafter represented by “Not updated”) is written into the update flag 102. For example, when the data 112b (document file A) is updated in the mobile telephone, the data manager 18 writes “Document file A” and “Updated” into the data identifier 101 and the update flag 102 of the corresponding record of the update information 100, respectively.

The following provides further description of the primary components of the mobile telephone 10 and the server 60, referring to FIG. 2 again.

When the connection monitor 17 detects that the mobile telephone 10 goes into the online state, the data manager 18 deletes data in the storage 16 of the mobile telephone 10 if the data is a copy of data stored in the storage 61 of the server 60. In the case of the example case shown in FIG. 2 and FIG. 3, when the connection monitor 17 detects that the mobile telephone 10 goes into the online state, the data manager 18 deletes the data 111b, whose update flag 102 indicates “Not updated” as shown FIG. 3, from the storage 16 of the mobile telephone 10.

Furthermore, when data updated within the mobile telephone 10 has been copied to the storage 61 of the server 60, the data manager 18 deletes the data from the storage 16 of the mobile telephone 10. In the example case shown in FIG. 2 and FIG. 3, the data 112b has been updated within the mobile telephone 10, and therefore the data manager 18 deletes it from the storage 16 of the mobile telephone 10 after receiving a notification of the completion of synchronization from the server 60. However, the data manager 18 does not delete the data 112b from the storage 16 of the mobile telephone 10 when the download condition is satisfied, which will be described later in detail. This is because the download condition, when satisfied, shows that the mobile telephone 10 is expected to be out of the coverage area 400 after a while and it is necessary to keep the data 112b within the mobile telephone 10.

The uploader 19 uploads the data 112b, which has been updated in the mobile telephone 10 as indicated by the update information 100, to the server 60 when the connection monitor 17 detects that the mobile telephone 10 goes into the online state. Here, when the user has got ready to update the data stored in the storage 16 of the mobile telephone 10, the data manager 18 makes a copy of the data before the update. Then, the user updates the copy by operating the application execution unit 12, and the data manager 18 extracts the difference between the updated data and the original data. The uploader 19 uploads data corresponding to the difference to the server 60.

The downloader 20 downloads the data set 110a from the server 60 before the mobile telephone 10 goes into the offline state in which the mobile telephone 10 cannot communicate with the server 60. For this purpose, the downloader 20 monitors whether the download condition is satisfied or not. The download condition is a condition indicating whether or not to download the data set 110a to the storage 16 of the mobile telephone 10. The data to be downloaded is, for example, all the files stored in a folder specified with a particular Uniform Resource Locator (URL).

The download condition is, for example, that the mobile telephone 10, whose position is obtained by the GPS processor 21, is expected to be out of a given geographic range after a predetermined time period (e.g. five minutes). The geographic range is represented by an area map 201 and indicates the range within which the mobile telephone 10 can communicate with the server 60. The area map 201 is a preset map. Whether the download condition is satisfied or not is determined through the following procedures. First, the GPS processor 21 obtains the current position and the travelling speed of the mobile telephone 10. Based on the current position and the travelling speed, the downloader 20 calculates the position of the mobile telephone 10 after the predetermined time period, and determines whether the position after the predetermined time period is out of the area map 201.

Another example of the download condition is that the time limit of the online state will be reached after a predetermined interval from the current time. If this is the case, the downloader 20 determines whether the mobile telephone 10 will go into the offline state after a predetermined interval from the current time, based on a schedule 202 and the current time obtained by the timer 14. The schedule 202 is a preset schedule indicating a time period for which the mobile telephone 10 can communicate with the server 60.

### <Operations>

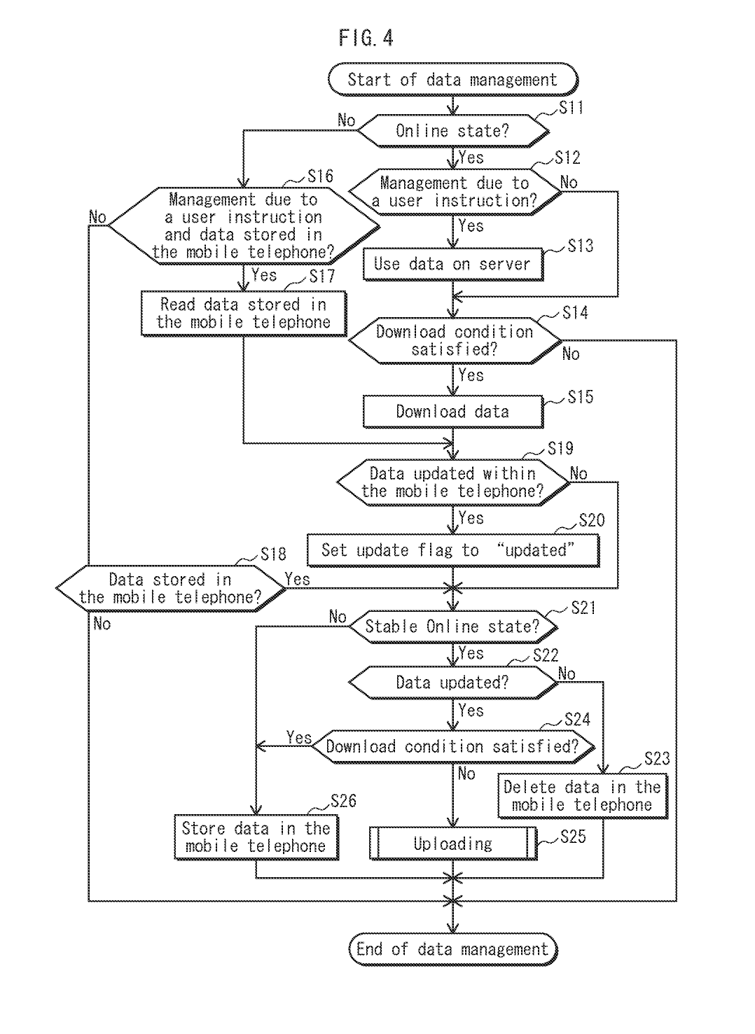

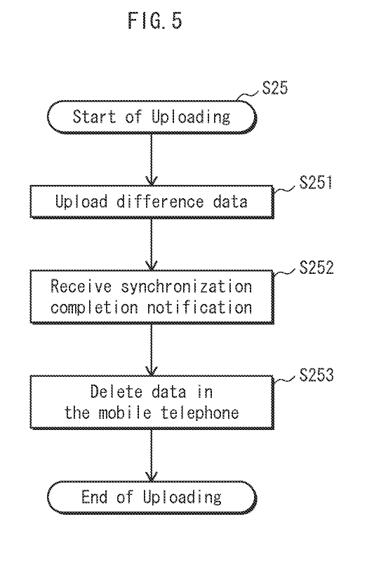

The following describes operations of the mobile telephone 10 with reference to FIG. 4 and FIG. 5 (and FIG. 2 with respect to the structure).

FIG. 4 is a flowchart showing data management performed by the mobile telephone 10.

This data management is started (i) when the user notifies the application execution unit 12 of the intention to use data, and the data manager 18 receives a data request from the application execution unit 12, or (ii) when the mobile telephone 10 is powered on. The data management started under the condition (i) above is hereinafter referred to as “the management due to a user instruction”, and the data management started under the condition (ii) above is hereinafter referred to as “the regular management”. The data request mentioned above is a signal used by the application execution unit 12 in order to request the data manager 18 for the data (i.e. the mail data 111b or the document data 112b) stored in the storage 16.

The following first describes general procedures of the data management, with reference to the flowchart shown in FIG. 4, and then describes specific examples of operations under the condition that the user is outside the coverage area 400. The examples include the case where the user browses the mail data 111b and the case where the user edits the document file 112b.

As seen from the flowchart shown in FIG. 4, the connection monitor 17 determines the connection state of the mobile telephone 10 with the server 60 in Step S11. When the connection monitor 17 determines that the mobile telephone 10 can communicate with the server 60 (Yes in Step S11), the data manager 18 determines whether or not the data manager 18 has received a data request from the application execution unit 12 (Step S12). That is, the data manager 18 determines whether the user has notified the application execution unit 12 of the intention to use data. When the data manger 18 has received the data request (Yes in Step S12), the data manager 18 manages the requested data stored in the storage 61 of the server 60 so as to use the data on the server 60 (Step S13). That is, the data manager 18 enables the application execution unit 12 to use the data stored in the storage 61 of the server 60 according to the user's intention.

Next, the downloader 20 determines whether the download condition is satisfied or not (Step S14). The download condition is a condition for starting the download of the data. When the download condition is satisfied (Yes in Step S14), the downloader 20 downloads (i.e. makes a copy of) the data stored in the server 60, and writes the data (i.e. the copy) into the storage 16 (Step S15). The data management unit 18 creates a record of the update information 100 for the downloaded (i.e. copied) data. Since the download condition is satisfied, the mobile telephone 10 is expected to go out of the coverage area 400. Then, the data management moves to Step S19. On the other hand, when the download condition is not satisfied (No in Step S14), the data management finishes.

In Step S19, the data manger 18 determines whether the data stored in the storage 16 of the mobile telephone 10 has been updated or not. That is, the data manger 18 determines whether the data manager 18 has received from the application execution unit 12 a notification indicating that the data has been updated. When determining that the data has been updated (Yes in Step S19), the data manager 18 writes “Updated” to the update flag 102 of the corresponding record in the update information 100 (Step S20). When determining that the data has not been updated (No in Step S19), the data management moves to Step S21.

In Step S21, the connection monitor 17 determines whether the mobile telephone 10 has gone into the stable online state, in which the mobile telephone 10 can stably communicate with the server 60. When the connection monitor 17 determines that the mobile telephone 10 has gone into the stable online state (Yes in Step S21), the data manager 18 specifies non-updated data stored in the storage 16 of the mobile telephone 10 (Step S22). The data manager 18 deletes the non-updated data from the storage 16 (Step S23). With respect to updated data in the storage 16, when the download condition is not satisfied (No in Step S24), the uploader 19 uploads the data to the server 60 (Step S25). Then, the data management finishes. On the other hand, when the download condition is satisfied (Yes in Step S24), the data manager 18 stores the updated data into the storage 16 of the mobile telephone 10 (Step S26). Then, the data management finishes.

The following describes the other cases shown in FIG. 4. As described above, the data management is performed as “the management due to a user instruction” or “the regular management”. When the mobile telephone 10 is outside the coverage area 400 and the “management due to a user instruction” is started, the connection monitor 17 determines in Step S11 that the mobile telephone 10 cannot communicate with the server 60 (No in Step S11). Next, the data manager 18 determines whether or not the data manager 18 has received a data request from the application execution unit 12 and whether or not the requested data is stored in the storage 16 of the mobile telephone 10 (Step S16). When determining that the data manager 18 has received the data request from the application execution unit 12 and the data is stored in the storage 16 of the mobile telephone 10 (Yes in Step S16), the data manger 18 reads the data from the storage 16 and passes the data to the application execution unit 12 (Step S17). Then, the data management moves to Step S19. When the mobile telephone 10 is outside the coverage area 400 and the “regular management” is started, the connection monitor 17 first determines in Step S11 that the mobile telephone 10 cannot communicate with the server 60 (No in Step S11). Next, when the data manger 18 determines in Step S18 that data is stored in the storage 16 of the mobile telephone 10 (No in Step S16 and Yes in Step S18), the data management moves to Step S21. When the data manager 18 determines in Step S18 that no data is stored in the storage 16 (No in Step S16 and No in Step S18), the data management finishes.

The following describes the uploading (Step S25), with reference to FIG. 5.

The uploader 19 refers to the update information 100 and uploads data corresponding to the difference of the updated data from the original data to the server 60 (Step S251). Then, the uploader 19 receives a notification of the completion of synchronization from the server 60 (Step S252). Thus, the uploader 19 recognizes that the data updated within the mobile telephone 10 has been written into the server 60. After the synchronization, the data manager 18 deletes the updated data from the storage 16 of the mobile telephone 10 (Step S253). Then, the uploading finishes.

<Data Management Performed when the User Outside the Coverage Area 400 Wishes to Browse the Mail Data 111b and Edit the Document Data 112b>

Assume the following case: initially, the mobile telephone 10 is inside the coverage area 400; then the mobile telephone 10 goes out of the coverage area 400 and the user uses the mail data 111b and the document data 112b outside the coverage area 400; and finally, the mobile telephone 10 goes into the coverage area 400 again. It is assumed that the mail data 111b and the document data 112b are initially not stored in the storage 16 of the mobile telephone 10. Also assume that mail data 111b will not be updated after being browsed, and the document file 112b will be updated after being edited.

First, when the mobile telephone 10 is inside the coverage area 400, the connection monitor 17 determines that the mobile telephone 10 can communicate with the server 60 (Yes in Step S11). As assumed above, the user does not use data when the mobile telephone 10 is inside the coverage area 400. Hence, the data management moves to Step S14 (No in Step S12). When the download condition is not satisfied (No in Step S14), it is expected that the mobile telephone 10 does not go out of the coverage area in the near feature. Therefore, the data management finishes without further processing. The mobile telephone 10 repeatedly performs these procedures.

Next, when the download condition is satisfied, the downloader 20 determines that the download condition is satisfied (Yes in Step S14), and downloads the mail data 111a and the document data 112a stored in the server 60 to the storage 16 of the mobile telephone 10 (Step S15). Then, the mobile telephone 10 goes out of the coverage area 400. That is, the mobile telephone 10 goes into the offline state in which the mobile telephone 10 cannot communicate with the server 60.

When the mobile telephone 10 is outside the coverage area 400, the data management will be “the regular management” or “the management due to a user instruction” as described above.

In the case of the regular management, the connection monitor 17 determines in Step S11 that the mobile telephone 10 cannot communicate with the server 60 (No in Step S11). Since the data management is the regular management (i.e. not stated due to the user's intention to use data), and the data set 110b is stored in the storage 16, the data management moves to Step S21 (No in Step S16 and Yes in Step S18). The connection monitor 17 determines that the mobile telephone 10 is in the offline state (No in Step S21), and the uploader 19 does not upload the mail data 111b and the document data 112b in the storage 16 to the server 60 (Step S26). Then, the data management finishes. The mobile telephone 10 repeatedly performs the above-described procedures.

In the case of the management due to a user instruction, the connection monitor 17 determines in Step S11 that the mobile telephone 10 cannot communicate with the server 60 (No in Step S11). Next, the data manager 18 determines that the data management is the management due to a user instruction and the storage 16 stores the data set 110b (i.e. the mail data 111b and the document data 112b) (Yes in Step S16), and reads the data set 110b (Step S17). The application execution unit 12 receives the data set 110b from the data manager 18. In the case of the browsing of the mail data 111b, the application execution unit 12 displays the mail data 111b on the touch panel 13. In the case of editing the document data 112b, the application execution unit 12 displays the document data 112b on the touch panel 13, and updates the document data 112b according to a user instruction. Then, the data manager 18 determines that the document data 112b has been updated (Yes in Step S19), and writes “Updated” to the update flag 102 of the document data 112b (i.e. the document file A) in the update information 100 (Step S20).

After that, the data manager 18 will repeatedly perform the determination as to whether the mobile telephone 10 goes into the stable online state (Step S21) until the mobile telephone 10 goes into the coverage area 400 again.

When the connection monitor 17 determines that the mobile telephone 10 has gone into the stable online state again (Yes in Step S21), the data manager 18 specifies non-updated data (i.e. the mail data 111b or the document data 112b) stored in the storage 16 of the mobile telephone 10 (Step S22). Since the mail data 111b has not been updated (No in Step S22), the data manager 18 deletes the mail data 111b from the storage 16 of the mobile telephone 10 (Step S23). On the other hand, since the document data 112b has been updated (Yes in Step S22), if the download condition is not satisfied (No in Step S24), the uploader 19 performs the uploading (Step S25).

As described above, during a period for which the mobile telephone 10 cannot communicate with the server 60, the mobile telephone 10 pertaining to the present embodiment can use data by keeping the data within the mobile telephone 10, and during a period for which the mobile telephone 10 can communicate with the server 60, the mobile telephone 10 does not store data and directly use the data on the server 60, and thus protect the data against information leakage when the mobile telephone 10 is stolen or lost.

### <Modification>

The mobile telephone 10 pertaining to embodiment described above downloads the data set 110a stored in the server 60 to the storage 16 of the mobile telephone 10 when the download condition is satisfied. The following describes a modification example in which the data set 110a stored in the server 60 is encrypted data and a decryption key for the encrypted data, and the mobile telephone 10 is provided with a decrypter.

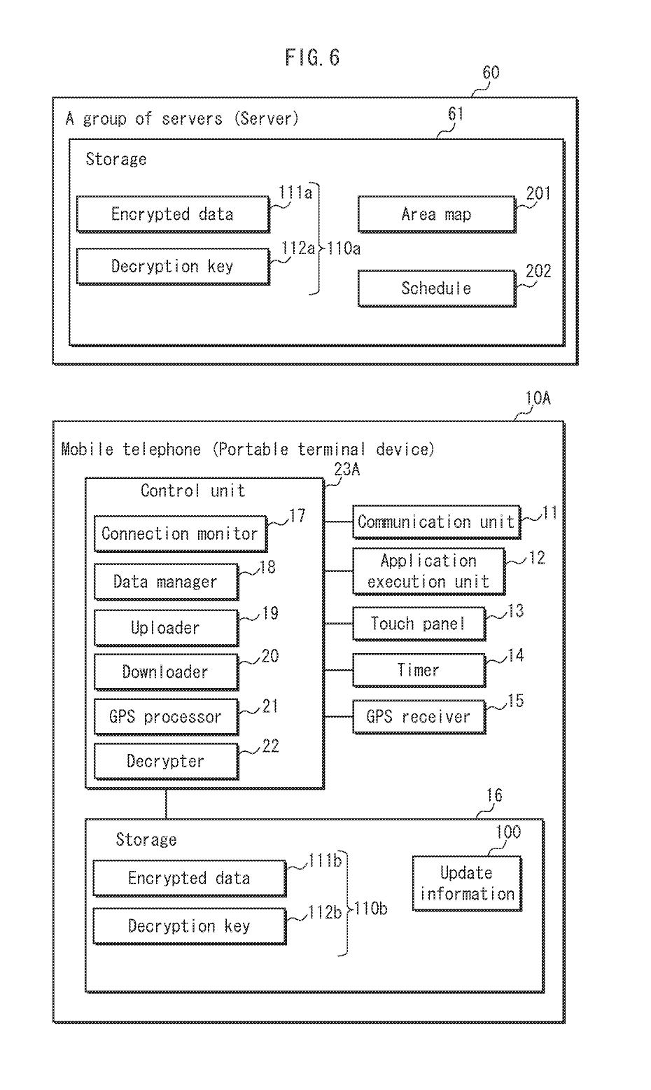

As shown in FIG. 6, a mobile telephone 10A pertaining to this modification example has a control unit 23A, which includes a decrypter 22.

The storage 61 of the server 60 stores encrypted data and a decryption key for the encrypted data.

The decrypter 22 decrypts the encrypted data, which is downloaded from the server 60, by using the decryption key, which is also downloaded from the server 60. The other functional components are the same as those in Embodiment described above.

When the mobile telephone 10A is in the online state in which the mobile telephone 10A can communicate with the server 60, the mobile telephone 10A downloads the encrypted data stored in the server 60 to the mobile telephone 10A regardless of whether the download condition is satisfied or not. After that, when the download condition is satisfied, the mobile telephone 10A downloads the decryption key for the encrypted data to the mobile telephone 10A. Next, the decrypter 21 decrypts the encrypted data by using the decryption key. Finally, the application execution unit 12 uses the data decrypted from the encrypted data.

With this structure, the mobile telephone 10A can start downloading the encrypted data before the download condition is satisfied. This is advantageous when there is only a short interval from when the download condition is satisfied to when the mobile telephone 10A goes into the offline state and the mobile telephone 10A can download only a small amount of data during such an interval. With the above-described structure, the mobile telephone 10A can spend a relatively long time for the downloading, and accordingly the mobile telephone 10A can download a relatively larger amount of data.

### <Supplemental Descriptions>

A portable terminal device pertaining to the present invention has been described above based on Embodiment and Modification. However, further modifications may be applied within the scope of the technical concept of the present invention. For example, the following modifications may be applied to the present invention.

(1) In Embodiment, each of the data set 110a and the data set 110b is composed of mail data and document data. However, the type of the data should not be limited in this way, and any kinds of data may be used as far as they can be stored in the storage 61 of the server 60 and the storage 16 of the mobile telephone 10. Examples of the data include: a specific file used in an e-mail application, such as an address book containing personal names, mail addresses, addresses, and occupations; configuration data for Virtual Private Network (VPN) and the likes; and application software.
(2) According to Embodiment and Modification above, when the data has been updated, the uploader 19 uploads the difference data to the server 60. However, it is acceptable that the data manager 18 does not make a copy of the data before the update of the data, and the uploader 19 uploads the entirety of the updated data to the server 60. If this is the case, the server 60 compares the received data with the original data stored in the server 60.
(3) According to Embodiment and Modification above, the download condition is related to positional information or time information, and it is determined based on the preset area map 201 or the preset schedule 202. However, the download condition should not be limited in this way, and other download conditions may be used as far as the mobile telephone 10 or 10A can make the determination before the mobile telephone 10 or 10A goes into the offline state. For example, the download condition may be that the intensity of the radio waves falls below a predetermined threshold value. Furthermore, although the area map 201 and the schedule 202 have been described as being stored in the storage 61 of the server 60, they may be stored in the storage 16 of the mobile telephone 10 or 10A.

In addition, the downloader 20 may download the data stored in the server 60 in response to a user instruction.

(4) In the description above, only the case of updating data in the mobile telephone 10 or 10A has been explained. However, the same explanation applies to the case of newly creating data in the mobile telephone 10 or 10A. If this is the case, a record is added to the update information 100 in correspondence with the newly created data, and the update flag 102 of the record is set to “Updated”.
(5) According to Embodiment and Modification above, the data to be used is always downloaded from the server 60. However, the present invention should not be limited in this way. For example, when there are a plurality of terminal devices, it is possible that only one of the terminal devices download the data from the server 60 and the rest of the devices use the data via a storage medium. If this is the case, the rest of the devices delete the data stored therein when going into the coverage area 400 of the mobile communication service again.
(6) Although not specifically described above, the mobile telephone 10 or 10A may display an icon on the touch panel 13 to indicate that the data is stored in only the server or in both the server and the terminal device. Such a modification allows the user to know the location where the data is stored.
(7) The changes (1) through (6) may be applied in combinations.
(8) The following describes the structure and advantageous effects of a portable terminal device pertaining to the present invention.

(a) One aspect of the present invention is a portable terminal device for using data stored in a server by communicating with the server via a network, comprising: a connection monitor that monitors a connection state of the portable terminal device with the server, the connection state switching between an online state and an offline state; and a data manager that deletes same data as data stored in the server from the portable terminal device when the connection monitor detects that the portable terminal device goes into the online state.

With the stated structure, the portable terminal device does not store the same data as the data stored in the server while the portable terminal device can communicate with the server, and stores the data while it cannot communicate with the server. Therefore, the data is protected against information leakage when the portable terminal device can communicate with the server, and also the data can be downloaded to and used in the portable terminal device when the portable terminal device cannot communicate with the server.

In the case of roaming performed outside the coverage area of the user's contracted mobile communication service, there is a possibility that data communication will be unavailable or the cost of the data communication will be high. However, with the stated structure, although the data is not stored in the portable terminal device while the portable terminal device is within the coverage area of the user's contracted service, in order to protect the data against information leakage when the mobile telephone 10 is stolen or lost, the data is stored in the portable terminal device when the portable terminal device is outside the coverage area. Therefore, when the portable terminal device is outside the coverage area and uses the roaming service, the portable terminal device can use the data without performing data communication with the server.

(b) The data manager deletes the data when the online state has continued for a predetermined time period.

With the stated structure, the portable terminal device deletes the data from the portable terminal device only when the portable terminal device can stably communicate with the server. Therefore, the structure prevents a problem that the portable terminal device deletes that data when the communication with the server is not stable and therefore cannot use the data when needed.

(c) The portable terminal device may further comprise: a downloader that monitors whether a download condition is satisfied, and when determining that the download condition is satisfied, downloads data from the server, wherein the data manager may be configured such that when the downloader determines that the download condition is satisfied, the data manager does not delete data from the portable terminal device regardless of whether the connection monitor has detected that the portable terminal device has gone into the online state.

With the stated structure, the portable terminal device downloads the data when the portable terminal device is outside the coverage area of the mobile communication service. Therefore, it is unnecessary to read the data from an external recording medium or the like.

(d) The portable terminal device may further comprise: a decrypter that decrypts encrypted data, wherein the data stored in the server may consist of encrypted data and a decryption key for decrypting the encrypted data, the downloader may: download the decryption key from the server when determining that the download condition is satisfied; and download the encrypted data when the connection monitor detects that the portable terminal device is in the online state regardless of whether the download condition is satisfied, and the decrypter may decrypt the encrypted data by using the decryption key.

With the stated structure, the portable terminal device downloads the encrypted data while the portable terminal device can communicate with the server, and downloads the decryption key immediately before the portable terminal device goes into the offline state. Due to this structure, the portable terminal device can start downloading the encrypted data before the download condition is satisfied. This is advantageous when there is only a short interval from when the download condition is satisfied to when the mobile telephone goes into the offline state and the portable terminal device can download only a small amount of data during such an interval. Therefore, the portable terminal device can spend a relatively long time for the downloading, and accordingly the portable terminal device can download a relatively larger amount of data.

(e) The portable terminal device may further comprise: a GPS processor acquiring a position and a travelling speed of the portable terminal device by using a global positioning system (GPS), wherein the download condition may be that the portable terminal device is expected to go out of a predetermined geographic range after a predetermined time period, the geographic range being represented by a preset area map and indicating a range within which the portable terminal device can communicate with the server.

With the stated structure, the portable terminal device starts downloading the data after determining the connectability to the server based on the present position and the area map of the mobile communication service. Therefore, the portable terminal device can surely predict the time at which the portable terminal device goes into the offline state. The portable terminal device may determine the connectability to the server based only on the present position without taking the traveling speed into consideration.

(f) The portable terminal device may further comprise: a timer that obtains current time, wherein the download condition may be that a time limit indicated by a preset schedule is to be reached after a predetermined interval from the current time, the time limit being defined as an end of a time period for which the portable terminal device can communicate with the server.

With the stated structure, the portable terminal device starts downloading the data after determining the connectability to the server based on the current time and the schedule. Therefore, the portable terminal device can download the data at an appropriate time that matches the user's schedule. For example, when the user travels by plane, the portable terminal device downloads the data according to the flight schedule before entering the offline state.

(g) The portable terminal device may further comprise: an uploader that uploads data to the server, wherein the data manager may determine whether the data downloaded from the server by the downloader has been updated within the portable terminal device, the uploader may upload the data to the server by using data management information when the connection monitor detects that the portable terminal device goes into the online state and the data manager determines that the data has been updated within the portable terminal device, and the data manager may delete the data updated within the portable terminal device when the uploader has uploaded the data to the server.

With the stated structure, the portable terminal device uploads the same data as the updated data to the server. Therefore, the portable terminal device can keep the consistency between the data in the portable terminal device and the data in the server.

(9) The functional components (17 through 22) included in the control unit 23 and the application execution unit 12 are realized by a built-in computer of the mobile telephone 10 or 10A executing a data management program. The functional components included in the Embodiment and the modifications may be realized with a hardware circuit such as an Integrated Circuit (IC) or a Large Scale Integration (LSI).

The data management program may be distributed via a recording medium or a communication channel. The program thus distributed will be stored in a memory or the like that can be read by the CPU of a device. The functions of the mobile telephone described above are realized by the CPU executing the program.

(10) The steps shown in the flowcharts pertaining to Embodiment are assumed to be performed sequentially in the order as shown in the flowchart. However, some steps may be performed in parallel or individually.

### INDUSTRIAL APPLICABILITY

A portable terminal device of the embodiment uses data stored in a server when the portable terminal device can communicate with the server, and when the portable terminal device cannot communicate with the server, the portable terminal device protects the data against information leakage. Thus, the present invention is applicable to a portable terminal device for using data stored in a server.

### REFERENCE SIGNS LIST

10 Mobile telephone
12 Application execution unit
13 Touch panel
14 Timer
15 GPS receiver
16 Storage (in the mobile telephone)
17 Connection monitor
18 Data manager
19 Uploader
20 Downloader
21 GPS processor
22 Decrypter
50 Communication network
60 Server
61 Storage (in the server)
100 Update information
110a, 110b Data set
201 Area map
202 Schedule

1. A portable terminal device for using data stored in a server by communicating with the server via a network, comprising:
a connection monitor that monitors a connection state of the portable terminal device with the server, the connection state switching between an online state and an offline state; and
a data manager that deletes same data as data stored in the server from the portable terminal device when the connection monitor detects that the portable terminal device goes into the online state.

2. The portable terminal device of claim 1, wherein
the data manager deletes the data when the online state has continued for a predetermined time period.

3. The portable terminal device of claim 2, further comprising:
a downloader that monitors whether a download condition is satisfied, and when determining that the download condition is satisfied, downloads data from the server, wherein
when the downloader determines that the download condition is satisfied, the data manager does not delete data from the portable terminal device regardless of whether the connection monitor has detected that the portable terminal device has gone into the online state.

4. The portable terminal device of claim 3, further comprising:
a decrypter that decrypts encrypted data, wherein
the data stored in the server consists of encrypted data and a decryption key for decrypting the encrypted data,
the downloader:
downloads the decryption key from the server when determining that the download condition is satisfied; and
downloads the encrypted data when the connection monitor detects that the portable terminal device is in the online state regardless of whether the download condition is satisfied, and
the decrypter decrypts the encrypted data by using the decryption key.

5. The portable terminal device of claim 3, further comprising:
a GPS processor acquiring a position and a travelling speed of the portable terminal device by using a global positioning system (GPS), wherein
the download condition is that the portable terminal device is expected to go out of a predetermined geographic range after a predetermined time period, the geographic range being represented by a preset area map and indicating a range within which the portable terminal device can communicate with the server.

6. The portable terminal device of claim 3, further comprising:
a timer that obtains current time, wherein
the download condition is that a time limit indicated by a preset schedule is to be reached after a predetermined interval from the current time, the time limit being defined as an end of a time period for which the portable terminal device can communicate with the server.

7. The portable terminal device of claim 3, further comprising:
an uploader that uploads data to the server, wherein
the data manager determines whether the data downloaded from the server by the downloader has been updated within the portable terminal device,
the uploader uploads the data to the server by using data management information when the connection monitor detects that the portable terminal device goes into the online state and the data manager determines that the data has been updated within the portable terminal device, and
the data manager deletes the data updated within the portable terminal device when the uploader has uploaded the data to the server.

8. A data management method used in a portable terminal device for using data stored in a server by communicating with the server via a network, the portable terminal device including a connection monitor and a data manager, the data management method comprising:
a step of the connection monitor monitoring a connection state of the portable terminal device with the server, the connection state switching between an online state and an offline state; and
a step of the data manger deleting same data as data stored in the server from the portable terminal device when the connection monitor detects that the portable terminal device goes into the online state.

9. A computer-readable non-transitory recording medium on which a data management program is recorded, the data management program causing a computer executing the data management program to serve as a portable terminal device for using data stored in a server by communicating with the server via a network, the data management program comprising:
a program code that causes the computer to monitor a connection state of the computer with the server, the connection state switching between an online state and an offline state; and
a program code that causes the computer to delete same data as data stored in the server from the computer when the connection monitor detects that the computer goes into the online state.
